(19) United States
(12) Patent Application Publication
(10) Pub. No.: US 2025/0336149 A1
(43) Pub. Date: Oct. 30, 2025

(54) THREE-DIMENSIONAL RECONSTRUCTION DEVICE, THREE-DIMENSIONAL RECONSTRUCTION METHOD, AND PROGRAM

(71) Applicant: NIPPON TELEGRAPH AND TELEPHONE CORPORATION, Tokyo (JP)

(72) Inventors: Mizuki TABATA, Tokyo (JP); Junichiro TAMAMATSU, Tokyo (JP); Ryo TANAKA, Tokyo (JP)

(73) Assignee: NIPPON TELEGRAPH AND TELEPHONE CORPORATION, Tokyo (JP)

(21) Appl. No.: 18/866,542

(22) PCT Filed: May 19, 2022
(86) PCT No.: PCT/JP2022/020886

§ 371 Date: Nov. 17, 2024

(51) Int. Cl. G06T 17/00; G06T 7/33; G06T 7/50; H04N 23/698

(52) U.S. Cl. CPC G06T 17/00; G06T 7/337; G06T 7/50; H04N 23/698

(57) ABSTRACT

A three-dimensional reconstruction device (10) according to the present disclosure includes: a panoramic image acquisition unit (111) configured to acquire a panoramic image obtained by imaging an interior of a target structure; a drawing information acquisition unit (112) configured to acquire a drawing of the interior of the structure and a ceiling height of the structure; a plan view generation unit (113) configured to generate a plan view of the interior of the structure based on the panoramic image and the ceiling height; a registration unit (116) configured to perform alignment between the generated plan view and the drawing and determine coordinate values of the plan view; and a three-dimensional coordinate calculation unit (117) configured to perform three-dimensional reconstruction of the structure based on the determined coordinate values of the plan view.

### TECHNICAL FIELD

The present disclosure relates to a three-dimensional reconstruction device, a three-dimensional reconstruction device method, and a program.

### BACKGROUND ART

In three-dimensional restoration techniques of the related art based on images of the interiors of structures, three-dimensional coordinates can be reconstructed through preprocessing, detection of wall surfaces, and calculation of three-dimensional coordinates. In the calculation of the three-dimensional coordinates, the calculation is performed based on the Manhattan-world hypothesis (see, for example, NPL 1 and NPL 2). The “Manhattan-world hypothesis” is a hypothesis that all walls of the interior of a structure are orthogonal. FIG. 12A illustrates an example of a drawing of the interior of a structure which is based on the Manhattan-world hypothesis. FIG. 12B illustrates an example of a drawing of the interior of a structure which is not based on the Manhattan-world hypothesis.

### CITATION LIST

### Non Patent Literature

[NPL 1] Sun, C., et al., “HorizonNet: Learning Room Layout With 1D Representation and Pano Stretch Data Augmentation”, CVPR, 2019.
[NPL 2] Yang, S T., et al., “DuLa-Net: A Dual-Projection Network for Estimating Room Layouts from a Single RGB Panorama”, CVPR, 2019.

### SUMMARY OF INVENTION

### Technical Problem

However, it is difficult to perform three-dimensional reconstruction for the interior of a structure in which not all walls are orthogonal, that is, which is not based on the Manhattan-world hypothesis. In this way, a technique for accurately performing three-dimensional reconstruction of an image of the interior of a structure in which an orthogonal system is not assumed is preferable.

An object of the present disclosure devised in view of such circumstances is to provide a technique for accurately performing three-dimensional reconstruction of an image of the interior of a structure in which an orthogonal system is not assumed.

### Solution to Problem

A three-dimensional reconstruction device according to an aspect of the present disclosure includes: a panoramic image acquisition unit configured to acquire a panoramic image obtained by imaging an interior of a target structure; a drawing information acquisition unit configured to acquire a drawing of the interior of the structure and a ceiling height of the structure; a plan view generation unit configured to generate a plan view of the interior of the structure based on the panoramic image and the ceiling height; a registration unit configured to perform alignment between the generated plan view and the drawing and determine coordinate values of the plan view; and a three-dimensional coordinate calculation unit configured to perform three-dimensional reconstruction of the structure based on the determined coordinate values of the plan view.

A three-dimensional reconstruction method according to another aspect of the present disclosure is a three-dimensional reconstruction method executed by a three-dimensional reconstruction device, the method including: a panoramic image acquisition step of acquiring a panoramic image obtained by imaging an interior of a target structure; a drawing information acquisition step of acquiring a drawing of the interior of the structure and a ceiling height of the structure; a plan view generation step of generating a plan view of the interior of the structure based on the panoramic image and the ceiling height; a registration step of performing alignment between the generated plan view and the drawing and determining coordinate values of the plan view; and a three-dimensional coordinate calculation step of performing three-dimensional reconstruction of the structure based on the determined coordinate values of the plan view.

Further, a program according to still another aspect of the present invention causes a computer to function as the three-dimensional reconstruction device according to the aspect of the present disclosure.

### Advantageous Effects of Invention

According to the present disclosure, it is possible to provide a technique for accurately performing three-dimensional reconstruction of an image of the interior of a structure in which an orthogonal system is not assumed.

### BRIEF DESCRIPTION OF DRAWINGS

FIG. 1 is a diagram illustrating a configuration example of a three-dimensional reconstruction device according to an embodiment of the present disclosure.

FIG. 2 is a diagram illustrating an example of a panoramic image acquired by a panoramic image acquisition unit.

FIG. 3 is a diagram illustrating an example of a drawing of the interior of the target structure acquired by the drawing information acquisition unit.

FIG. 4 is a diagram schematically illustrating an example in which coordinate axes are given to a panoramic image for description.

FIG. 5 is a cross-sectional view illustrating a structure in which a camera capturing image is installed inside the structure.

FIG. 6 is a diagram illustrating an example of a plan view configured by a point group acquired by a plan view generation unit.

FIG. 7 is a diagram illustrating an example of a plan view from which a straight line is detected by a first straight line detection unit.

FIG. 8 is a diagram illustrating an example of a drawing from which a straight line is detected by a second straight line detection unit.

FIG. 9A is a flowchart illustrating an example of an operation of the three-dimensional reconstruction device according to an embodiment of the present disclosure.

FIG. 9B is a flowchart illustrating an example of an operation of the three-dimensional reconstruction device according to an embodiment of the present disclosure.

FIG. 10A is a flowchart illustrating an example of an operation of a three-dimensional reconstruction device according to a first modification example of the present disclosure.

FIG. 10B is a flowchart illustrating an example of an operation of a three-dimensional reconstruction device according to the first modification example of the present disclosure.

FIG. 11A is a flowchart illustrating an example of an operation of a three-dimensional reconstruction device according to a second modification example of the present disclosure.

FIG. 11B is a flowchart illustrating an example of an operation of a three-dimensional reconstruction device according to the second modification example of the present disclosure.

FIG. 12A is a diagram illustrating an example of a drawing of the interior of a structure which is based on the Manhattan-world hypothesis.

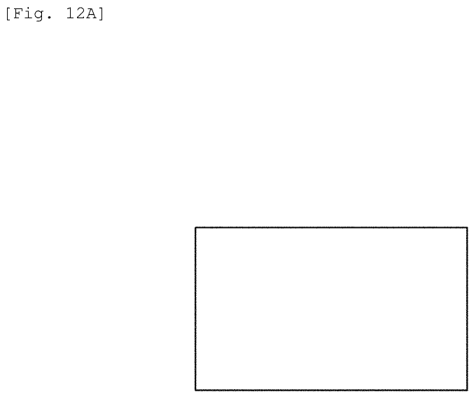

FIG. 12B is a diagram illustrating an example of a drawing of the interior of a structure which is not based on the Manhattan-world hypothesis.

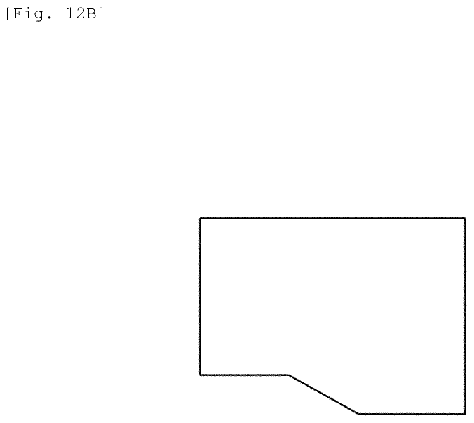

### DESCRIPTION OF EMBODIMENTS

Hereinafter, an embodiment of the present disclosure will be described with reference to the drawings. In the drawings, the same or corresponding units are denoted by the same reference numerals. In the description of the present embodiment, description of the same or corresponding units will be appropriately omitted or simplified. Embodiments to be described below are configuration examples of the present disclosure and are not intended to limit the present disclosure.

A three-dimensional reconstruction device 10 according to the present embodiment is a computer such as a server belonging to a cloud computing system or another computing system.

### <Configuration of Three-Dimensional Reconstruction Device 10>

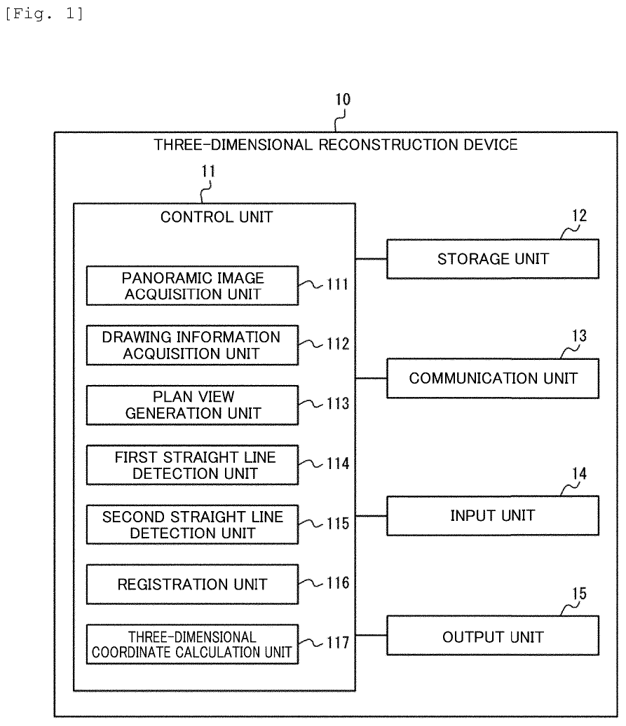

An example of a configuration of the three-dimensional reconstruction device 10 according to the present embodiment will be described with reference to FIG. 1. As illustrated in FIG. 1, the three-dimensional reconstruction device 10 includes a control unit 11, a storage unit 12, a communication unit 13, an input unit 14, and an output unit 15.

The storage unit 12 includes one or more memories and may include, for example, a semiconductor memory, a magnetic memory, and an optical memory. Each of the memories included in the storage unit 12 may function as, for example, a main storage device, an auxiliary storage device, or a cache memory. The storage unit 12 stores any information to be used for an operation of the three-dimensional reconstruction device 10. The storage unit 12 may not be provided inside the three-dimensional reconstruction device 10 or may be provided outside of the three-dimensional reconstruction device 10.

The communication unit 13 includes at least one communication interface. The communication interface is, for example, a LAN interface. The communication unit 13 receives information used for an operation of the three-dimensional reconstruction device 10, and transmits information obtained through an operation of the three-dimensional reconstruction device 10.

The communication unit 13 enables the three-dimensional reconstruction device 10 to transmit and receive information to and from another device via a network. The network includes the Internet, at least one wide area network (WAN), at least one metropolitan area network (MAN), or a combination thereof. The network may include at least one wireless network, at least one optical network, or a combination thereof. The wireless network is, for example, an ad hoc network, a cellular network, a wireless local area network (LAN), a satellite communication network, or a terrestrial microwave network.

The input unit 14 includes at least one input interface. The input interface is, for example, a physical key, a capacitance type key, a pointing device, a touch screen provided integrally with a display, or a microphone. The input unit 14 receives an operation of inputting information used for an operation of the three-dimensional reconstruction device 10. The input unit 14 may be connected to the three-dimensional reconstruction device 10 as an external input device instead of being provided in the three-dimensional reconstruction device 10. As a connection scheme, for example, any scheme such as Universal Serial Bus (USB), High-Definition Multimedia Interface (HDMI) (registered trademark), or Bluetooth (registered trademark) can be used.

The output unit 15 includes at least one output interface. The output interface is, for example, a display or a speaker. The display is, for example, a liquid crystal display (LCD) or an organic electro luminescence (EL) display. The output unit 15 may include a device such as VR goggles which a user can wear. The output unit 15 outputs information obtained through an operation of the three-dimensional reconstruction device 10. The output unit 15 may be connected to the three-dimensional reconstruction device 10 as an external output device instead of being provided in the three-dimensional reconstruction device 10. As a connection scheme, for example, any scheme such as USB, HDMI (registered trademark), or Bluetooth (registered trademark) can be used.

The control unit 11 is implemented by a control arithmetic circuit (controller). The control arithmetic circuit may be configured with dedicated hardware such as an application specific integrated circuit (ASIC) or a field-programmable gate array (FPGA), may be configured with a processor, or may be configured with both dedicated hardware and a processor. The control unit 11 performs processing related to an operation of the three-dimensional reconstruction device 10 while controlling each unit of the three-dimensional reconstruction device 10. The control unit 11 can transmit and receive information to and from an external device via the communication unit 13 and a network.

The control unit 11 includes a panoramic image acquisition unit 111, a drawing information acquisition unit 112, a plan view generation unit 113, a first straight line detection unit 114, a second straight line detection unit 115, a registration unit 116, and a three-dimensional coordinate calculation unit 117.

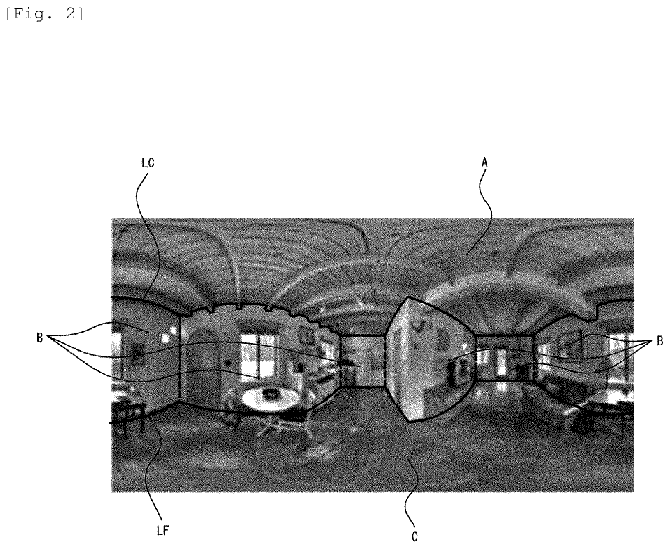

The panoramic image acquisition unit 111 acquires a panoramic image I obtained by imaging the interior of a target structure S. FIG. 2 illustrates an example of the panoramic image I acquired by the panoramic image acquisition unit 111. The panoramic image I is an image obtained by imaging the interior of the structure S at an angle from −90 degrees to +90 degrees in the vertical direction oriented in the perpendicular direction and at an angle of 0 degrees to 360 degrees in the horizontal direction by a camera or the like. In the panoramic image I of FIG. 2, an area A indicates the ceiling of the interior of the structure S, an area B indicates wall surfaces, and an area C indicates a floor surface. The panoramic image I includes a first boundary line LC which is a boundary line between a wall surface and the ceiling and a second boundary line LF which is a boundary line between the wall surface and the floor surface, which are detected in advance. In the panoramic image I illustrated in FIG. 2, the boundary lines LC and LF are indicated by solid lines. The detection of the boundary lines LC and LF may be performed by any image processing technique such as deep learning.

Any scheme may be adopted as a scheme of acquiring the panoramic image I. For example, the panoramic image acquisition unit 111 may directly acquire the panoramic image I from an external device such as a terminal device including a camera via the communication unit 13 or may directly acquire the panoramic image I input by a user via the input unit 14. The panoramic image acquisition unit 111 may acquire the panoramic image I by reading the panoramic image I stored in advance in the storage unit 12.

The panoramic image acquisition unit 111 outputs the acquired panoramic image I to the plan view generation unit 113.

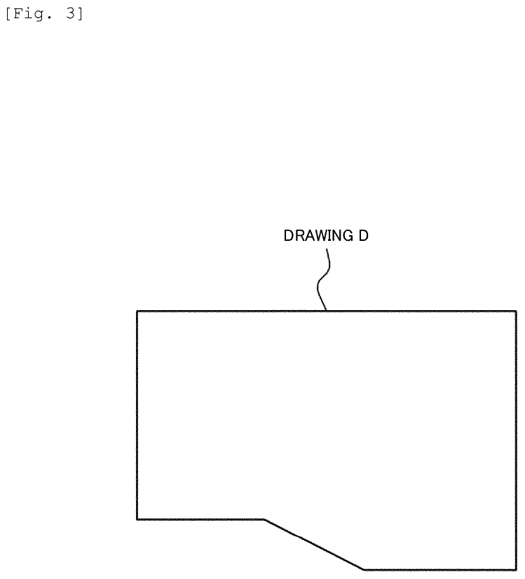

The drawing information acquisition unit 112 acquires drawing information indicating the drawing D of the interior of the target structure S and ceiling height information indicating a ceiling height of the target structure S. The drawing D is specifically a plan completion drawing of the target structure S. FIG. 3 illustrates an example of the drawing D of the target structure S acquired by the drawing information acquisition unit 112. Specifically, the drawing information is information including coordinate values of a point group representing the drawing D.

Any scheme may be adopted to acquire the drawing information and the ceiling height information. For example, the drawing information acquisition unit 112 may analyze an image representing the drawing D input from the input unit 14 by the user in accordance with any image processing technique to acquire the drawing information and the ceiling height information.

The drawing information acquisition unit 112 outputs drawing information to the second straight line detection unit 115. The drawing information acquisition unit 112 also outputs the ceiling height information to the plan view generation unit 113.

The plan view generation unit 113 acquires the panoramic image I and the ceiling height information. The plan view generation unit 113 generates a plan view P of the interior of the structure S based on the panoramic image I and the ceiling height indicated by the ceiling height information. Specifically, the plan view generation unit 113 calculates coordinate values of a point group representing the plan view P. The plan view generation unit 113 may generate the plan view P by calculating coordinates from the panoramic image I in accordance with any image processing technique.

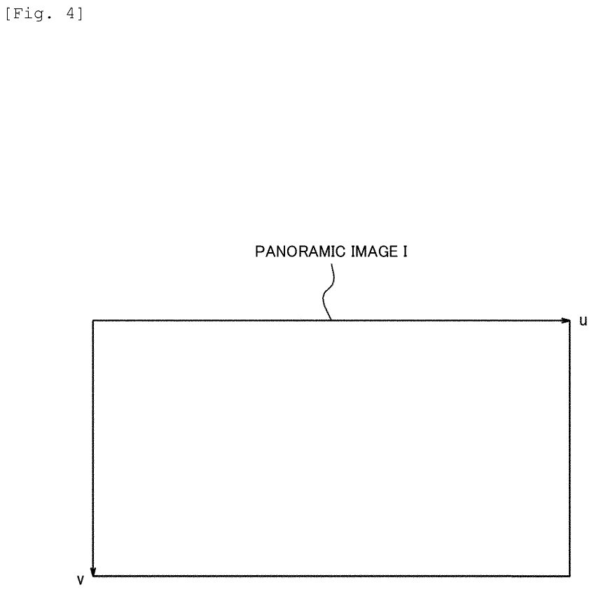

FIG. 4 is a diagram schematically illustrating an example in which coordinate axes are given to the panoramic image I for description. In FIG. 4, the v axis represents an angle (elevation angle) from −90 degrees to +90 degrees when the camera images the interior of the structure S in the vertical direction oriented in the perpendicular direction, and the u axis represents an angle (azimuth angle) from 0 degrees to 360 degrees when the camera image the interior of the structure S in the horizontal direction. That is, it can be understood that the width W of the panoramic image I corresponds to the u axis and a height H corresponds to the v axis, and coordinates (u_{c}, V_{c}) of any pixel of the boundary line LC and coordinates (u_{f}, V_{f}) of any pixel of the boundary line LF of the panoramic image I are obtained. u_{c} and u_{f}∈[0, W], V_{c} and V_{f}∈[0, H].

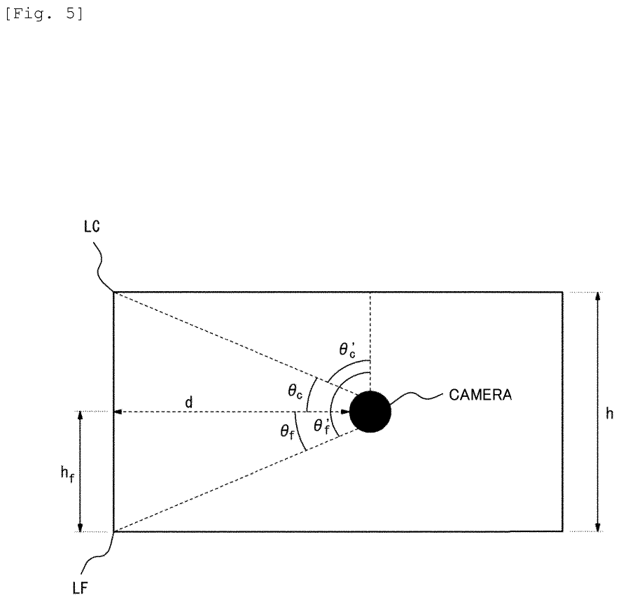

FIG. 5 is a cross-sectional view illustrating the structure S and a diagram illustrating an aspect in which the camera images the panoramic image I is installed inside the structure S. In FIG. 5, θ_{c} represents an imaging angle of the camera from a plane parallel to the ceiling or the floor surface to the boundary line LC at a position of a height from the floor surface of the camera. θ_{f} represents an imaging angle of the camera from the plane parallel to the ceiling or the floor surface to the boundary line LF at a position of a height from the floor surface of the camera. In this embodiment, θ_{c} corresponds to the element vc of the v axis of the coordinates of the above-mentioned pixel, and Of corresponds to vf.

In order to obtain θ_{c} and θ_{f}, the plan view generation unit 113 first obtains θ′_{c} and θ′_{f} ∈[−n/2, n/2] in FIG. 5. Here, θ including θ′_{c} and θ′_{f} can be calculated by the following Formula 1.

$$\begin{matrix}[ Math . 1 ] & \\ {θ}^{′} = - ( \frac{v + 0.5}{H} - 0.5 ) π & ( Formula 1 )\end{matrix}$$

Accordingly, the plan view generation unit 113 calculates θ_{c} from the following Formula 2.

$$\begin{matrix}[ Math . 2 ] & \\ {θ}_{c} = \frac{π}{2} - {θ}_{c}^{′} & ( Formula 2 )\end{matrix}$$

Further, the plan view generation unit 113 calculates θ_{f} from the following Formula 3.

$$\begin{matrix}[ Math . 3 ] & \\ {θ}_{f} = {θ}_{f}^{′} - \frac{π}{2} & ( Formula 3 )\end{matrix}$$

The plan view generation unit 113 calculates a height hf from the floor of the camera illustrated in FIG. 5 using the ceiling height h of the interior of the structure S indicated by the ceiling height information acquired from the drawing information acquisition unit 112 in accordance with the following Formula 4.

$$\begin{matrix}[ Math . 4 ] & \\ {h}_{f} = \frac{tan {θ}_{f}}{tan {θ}_{c} + tan {θ}_{f}} h & ( Formula 4 )\end{matrix}$$

Subsequently, the plan view generation unit 113 uses the ceiling height h to calculate a distance d to the wall surface from the position of the height of the camera from the floor surface of the interior of the structure S in accordance with following Formula 5.

$$\begin{matrix}[ Math . 5 ] & \\ d = \frac{1}{tan {θ}_{c} + tan {θ}_{f}} h & ( Formula 5 )\end{matrix}$$

The plan view generation unit 113 plots a point at a position of the distance d to the wall surface by applying the above Formula 5 for each u coordinate. For each of the plotted points, the plan view generation unit 113 acquires the coordinate value of a point group configuring the plan view P by determining the position of the distance d as x-axis and y-axis coordinate values and determining the height hf from the floor of the camera as a z-axis coordinate value. In this way, the plan view generation unit 113 generates the plan view P by obtaining the distance d of the camera imaging the panoramic image I to the wall surface and plotting the distance d at each imaging angle in the horizontal direction of the camera.

The present disclosure is not limited to the above description, and the plan view generation unit 113 may determine the distance d to the wall surface of the camera in accordance with any scheme. For example, the plan view generation unit 113 may determine the distance d using a detection results of a distance sensor, a depth camera, or the like.

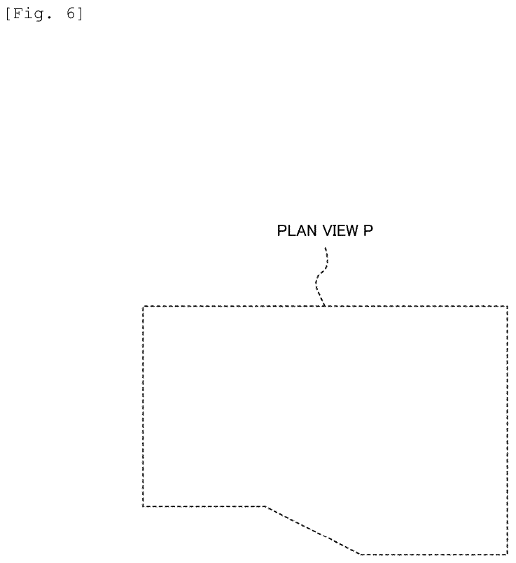

FIG. 6 illustrates an example of the plan view P configured by the point group acquired by the plan view generation unit 113. The plan view generation unit 113 outputs plan view information indicating the generated plan view P to the first straight line detection unit 114.

The first straight line detection unit 114 detects a straight line in the plan view P indicated by the plan view information acquired from the plan view generation unit 113 in accordance with a line segment detector (LSD) method. The present disclosure is not limited thereto and any scheme may be adopted to detect a straight line.

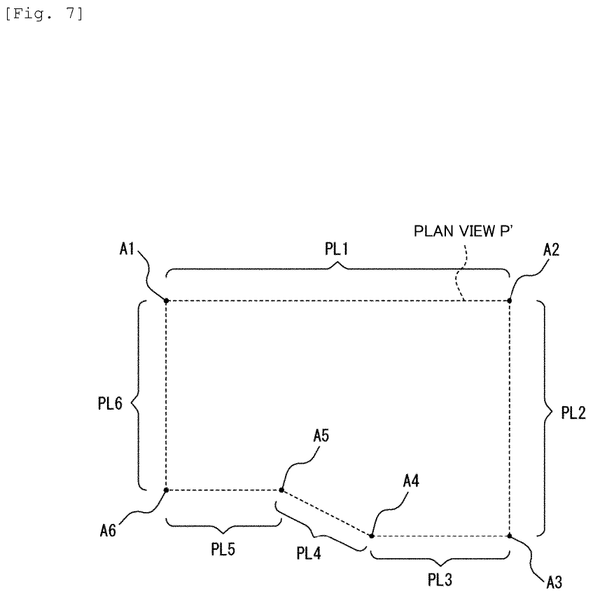

FIG. 7 is a diagram illustrating the plan view P in which straight lines PL1 to PL6 are detected by the first straight line detection unit 114 from the plan view P indicated by the plan view information. The first straight line detection unit 114 specifies at least one intersection of the detected straight lines as a first intersection. In the plan view P of FIG. 7, intersections specified by the first straight line detection unit 114 are indicated by circle marks with A1 to A6. The first straight line detection unit 114 outputs first intersection information indicating the specified intersections to the registration unit 116 along with the plan view information including a point group other than the intersections.

The second straight line detection unit 115 detects a straight line in the drawing D indicated by the drawing information acquired from the drawing information acquisition unit 112 by the LSD method, as in the first straight line detection unit 114. The present disclosure is not limited thereto and any scheme may be adopted to detect a straight line.

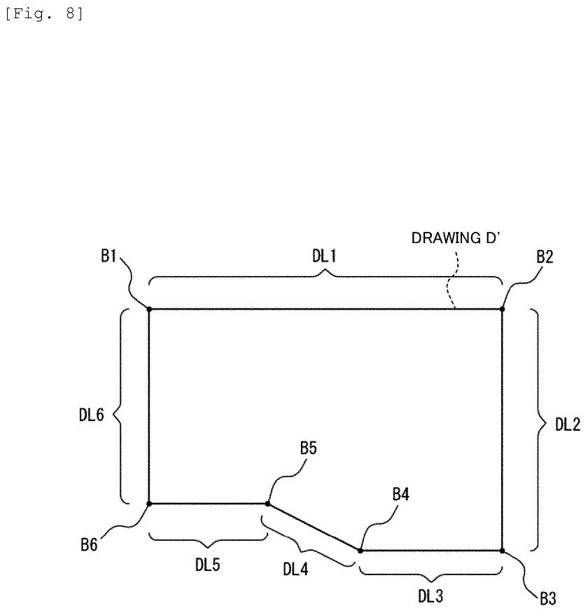

FIG. 8 is a diagram illustrating a drawing D′ in which straight lines DL1 to DL6 are detected from the drawing D indicated by the drawing information by the second straight line detection unit 115. The second straight line detection unit 115 specifies at least one intersection of the detected straight lines as a second intersection. In the drawing D′ of FIG. 8, intersections specified by the second straight line detection unit 115 are indicated by circle marks denoted by B1 to B6. The second straight line detection unit 115 outputs second intersection information indicating the specified intersection to the registration unit 116 along with the drawing information including a point group other than the intersection.

The registration unit 116 performs alignment between the point group representing the plan view P′ and the point group representing the drawing D′ based on the plan view information output from the first straight line detection unit 114 and the drawing information output from the second straight line detection unit 115. In the present embodiment, the registration unit 116 performs alignment using a scheme such as an interactive closest point (ICP) algorithm. The present disclosure is not limited thereto and the registration unit 116 may perform alignment using any algorithm.

The ICP algorithm is one of algorithms for aligning a plurality of three-dimensional point groups. The ICP algorithm is disclosed, for example, in the following literature. Literature 1: Besl, P. J. and N. D. Mckay (1992), “A method for registration of 3-D shapes”, IEEE Transactions on Pattern Analysis and Machine Intelligence 14 (2): 239-256.

The ICP algorithm estimates a rotation matrix R and a translation matrix T for aligning Pₛ with Pₜ when dimensional point groups Pₛ and Pₜ acquired from different positions are given. Specifically, the registration unit 116 performs the following procedures 1 to 4.

In procedure 1, the registration unit 116 obtains a nearest point Pₜⱼ in a point group Pₜ for each point Psi of the point group Pₛ using a nearest neighbor detection algorithm, and sets a corresponding point of the point Psi as the point Pₜⱼ. Since the corresponding point is reset in procedures 3 and 4, as will be described below, a first corresponding point is referred to as an “initial position”. The registration unit 116 includes the first intersection indicated by the first intersection information output from the first straight line detection unit 114 and the second intersection indicated by the second intersection information output from the second straight line detection unit 115 in the initial position and performs alignment. The registration unit 116 performs repetitive processing without using the first intersection and the second intersection in the following procedures 3 and 4. Since the nearest neighbor detection algorithm is disclosed in the following Literature 2, detailed description thereof will be omitted.

Literature 2: Eggert, D. W., et al. (1997), “Estimating 3-D rigid body transformations: a comparison of four major algorithms”, Machine Vision and Applications 9 (5): 272-290. In procedure 2, an objective function E between the corresponding points determined in procedure 1 is defined, and R and T at which E converges are estimated.

In procedure 3, Pₛ is moved by R and T obtained in procedure 2. In procedure 4, the above procedures 1 to 3 are repeated.

In the ICP algorithm, when the coordinates of the initial positions of two corresponding point groups are greatly different, alignment is failed and the point group is not determined at a position of the original three-dimensional coordinates. In this embodiment, the registration unit 116 can set the initial position robustly by using the first intersection detected by the first straight line detection unit 114 and the second intersection detected by the second straight line detection unit 115 as landmarks.

In this way, the registration unit 116 performs alignment using the first intersection indicated by the first intersection information output from the first straight line detection unit 114 and the second intersection indicated by the second intersection information output from the second straight line detection unit 115 as initial positions.

The point group of a result obtained through the alignment by the registration unit 116 represents the shape of the boundary line between the wall surface of the target structure S and the ceiling and the floor surface, that is, a shape of a plan view P″. In this way, the registration unit 116 performs the alignment of the generated plan view P′ and the drawing D′, and determines the coordinate values of the plan view P″. The registration unit 116 outputs information indicating coordinate values of the determined plan view P″ to the three-dimensional coordinate calculation unit 117.

The three-dimensional coordinate calculation unit 117 performs three-dimensional reconstruction of the target structure S. More specifically, the three-dimensional coordinate calculation unit 117 acquires information indicating coordinate values of the plan view P″ determined by the registration unit 116. Further, the three-dimensional coordinate calculation unit 117 calculates three-dimensional coordinates for the whole shape of the interior of the structure S other than the shape of the boundary line indicated by the plan view P″. Any scheme may be adopted to acquire the information. The three-dimensional coordinate calculation unit 117 stores information indicating the three-dimensional coordinates of the target structure S reconstructed in this way in the storage unit 12.

### <Program>

A computer capable of executing program instructions can be caused to function as the above-described three-dimensional reconstruction device 10. Here, the computer may be a general-purpose computer, a dedicated computer, a workstation, a personal computer (PC), an electronic notepad, or the like. The program instructions may be program codes, code segments, or the like for executing necessary tasks.

The computer includes a processor, a storage unit, an input unit, an output unit, and a communication interface. The processor is a central processing unit (CPU), a micro processing unit (MPU), a graphics processing unit (GPU), a digital signal processor (DSP), or a system on a chip (SoC) and may be configured with a plurality of same or different types of processors. The processor controls each of the above configurations and performs various arithmetic operations by reading a program from the storage unit and executing the read program. At least a part of the processing content may be implemented by hardware. The input unit is an input interface receiving an input operation of a user and acquiring information based on the input operation of the user, and is a pointing device, a keyboard, a mouse, or the like. The output unit is an output interface outputting information and is a display, a speaker, or the like. The communication interface is an interface for communication with an external device.

The program may also be recorded on a computer-readable recording medium. When such a recording medium is used, the program can be installed on the computer. Here, the recording medium on which the program is recorded may be a non-transitory recording medium. Although not particularly limited, the non-transitory recording medium may be, for example, a CD-ROM, a DVD-ROM, a USB memory, or the like. The program may be downloaded from an external device via a network.

### <Operation of Three-Dimensional Reconstruction Device 10>

Next, the operation of the three-dimensional reconstruction device 10 according to the present embodiment will be described with reference to FIGS. 4, 5, 9A, and 9B. The operation of the three-dimensional reconstruction device 10 corresponds to a three-dimensional reconstruction method according to the present embodiment.

In step S1, the panoramic image acquisition unit 111 of the control unit 11 acquires the panoramic image I obtained by imaging the interior of the target structure S. The panoramic image I includes the first boundary line LC which is a boundary line between a wall surface and a ceiling and the second boundary line LF which is a boundary line between the wall surface and a floor surface, which are detected in advance. The boundary lines LC and LF may be detected by any image processing technique such as deep learning. Any scheme may be adopted as a method of acquiring the panoramic image. The panoramic image acquisition unit 111 outputs the acquired panoramic image I to the plan view generation unit 113.

In step S2, the drawing information acquisition unit 112 acquires the drawing information indicating the drawing D of the interior of the target structure S and the ceiling height information indicating the ceiling height of the target structure S. Any scheme may be adopted to acquire the drawing information and the ceiling height information. The drawing information acquisition unit 112 outputs the drawing information to the second straight line detection unit 115. The drawing information acquisition unit 112 also outputs the ceiling height information to the plan view generation unit 113.

In step S3, the plan view generation unit 113 acquires the panoramic image I and the ceiling height information. The plan view generation unit 113 generates the plan view P based on the panoramic image I and the ceiling height indicated by the ceiling height information. Specifically, the plan view generation unit 113 calculates coordinate values of a point group representing the plan view.

In order to obtain θ_{c} and θ_{f} in FIG. 5, the plan view generation unit 113 first obtains θ′_{c} and θ′_{f} of [−n/2, n/2] in FIG. 5. Here, θ′ including θ′_{c} and θ′_{f} can be calculated by the above-described Formula 1. The plan view generation unit 113 calculates θ_{c} from the above-described Formula 2 and calculates θ_{f} from the above-described Formula 3. The plan view generation unit 113 calculates the height hf of the camera from the floor illustrated in FIG. 5 using the ceiling height h of the interior of the structure S indicated by the ceiling height information acquired from the drawing information acquisition unit 112 in accordance with the above-described Formula 4. Subsequently, the plan view generation unit 113 calculates the distance d from the position of the height of the camera from the floor surface of the interior of the structure S to the wall surface using the ceiling height h, from the above-described Formula 5.

The plan view generation unit 113 plots a point at a position of the distance d to the wall surface by applying the above Formula 5 for each u coordinate in FIG. 4. A plan view generation unit 113 determines the position of the distance d as an x-axis and a y-axis coordinate value and the height hf from the floor of the camera as a Z-axis coordinate value for each point to be plotted, thereby acquiring the coordinate value of a point group constituting the plan view P. In this way, the plan view generation unit 113 obtains the distance d to the wall surface of the camera imaging the panoramic image I, and plots the distance d at each imaging angle in the horizontal direction of the camera to generate the plan view P. The plan view generation unit 113 outputs the plan view information indicating the generated plan view P to the first straight line detection unit 114.

In step S4, the first straight line detection unit 114 detects a straight line in the plan view P indicated by the plan view information acquired from the plan view generation unit 113 by the LSD method. The present disclosure is not limited thereto, and any scheme may be adopted to detect the straight line. The first straight line detection unit 114 specifies at least one intersection of the detected straight lines as the first intersection. The first straight line detection unit 114 outputs the first intersection information indicating the specified intersection to the registration unit 116 along with the plan view information including a point group other than the intersection.

In step S5, the second straight line detection unit 115 detects a straight line in the drawing D indicated by the drawing information acquired from the drawing information acquisition unit 112 by the LSD method, as in the first straight line detection unit 114. The present disclosure is not limited thereto and any scheme may be adopted to detect a straight line. The second straight line detection unit 115 specifies at least one intersection of the detected straight lines as the second intersection. The second straight line detection unit 115 outputs the second intersection information indicating the specified intersection to the registration unit 116 along with drawing information including a point group other than the intersection.

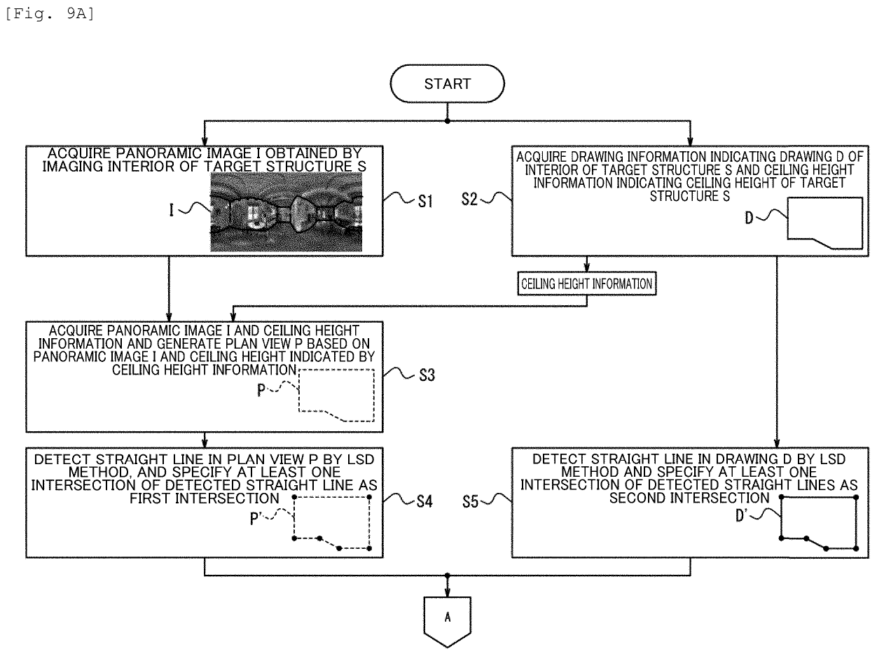

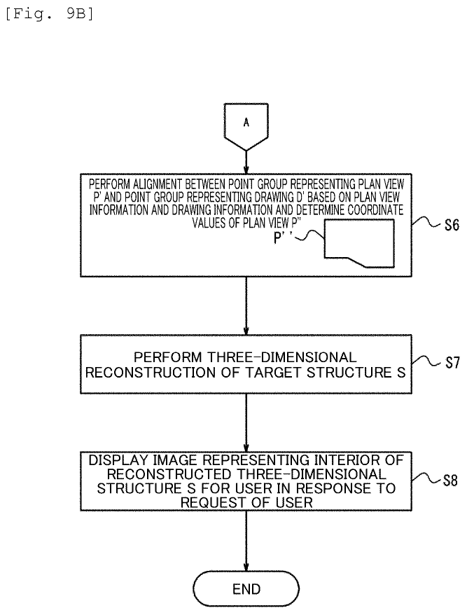

In step S6 of FIG. 9B, the registration unit 116 performs the alignment between the point group representing the plan view P and the point group representing the drawing D based on the plan view information output from the first straight line detection unit 114 and the drawing information output from the second straight line detection unit 115. Specifically, the registration unit 116 performs the alignment using the first intersection indicated by the first intersection information output from the first straight line detection unit 114 and the second intersection indicated by the second intersection information output from the second straight line detection unit 115 as the initial positions. In the present embodiment, the registration unit performs the alignment using a scheme such as an ICP algorithm. The present disclosure is not limited thereto and the registration unit 116 may perform the alignment using any algorithm.

The point group of a result of the alignment by the registration unit 116 represents the shape of the boundary line between the wall surface, and the ceiling and the floor surface of the target structure S, that is, the shape of the plan view P″. In this way, the registration unit 116 performs the alignment of the generated plan view P′ and the drawing D′, and determines the coordinate values of the plan view P″. The registration unit 116 outputs information indicating the coordinate values of the determined plan view P″ to the three-dimensional coordinate calculation unit 117.

In step S7, the three-dimensional coordinate calculation unit 117 performs three-dimensional reconstruction of the target structure S. More specifically, the three-dimensional coordinate calculation unit 117 acquires information indicating the coordinate values of the plan view P″ determined by the registration unit 116. Further, the three-dimensional coordinate calculation unit 117 calculates three-dimensional coordinates of the whole shape of the interior of the structure S other than the shape of the boundary line represented by the plan view P″. Any scheme may be adopted to acquire the information. The three-dimensional coordinate calculation unit 117 stores information indicating the three-dimensional coordinates of the target structure S reconstructed in this way in the storage unit 12.

In step S8, the control unit 11 displays an image representing the interior of the reconstructed three-dimensional structure S for the user in response to a request of the user. Any scheme may be adopted for the display to the user. For example, the control unit 11 can display an image to the user via the output unit 15. The control unit 11 may communicate with a terminal device used by the user via the communication unit 13 and transmit the image to the terminal device. Thereafter, the operation of the three-dimensional reconstruction device 10 ends.

As described above, the three-dimensional reconstruction device 10 according to the present embodiment includes: the panoramic image acquisition unit 111 that acquires a panoramic image obtained by imaging the interior of a target structure; the drawing information acquisition unit 112 that acquires a drawing of the interior the structure and a ceiling height of the structure; the plan view generation unit 113 that generates a plan view of the interior of the structure based on the panoramic image and the ceiling height; the registration unit 116 that performs alignment between the generated plan view and the drawing and determines coordinate values of the plan view; and the three-dimensional coordinate calculation unit 117 that performs three-dimensional reconstruction of the structure based on the determined coordinate values of the plan view.

According to the present embodiment, the coordinates of the plan view can be finally determined by correcting the generated plan view with the drawing through the alignment for matching the plan view with the drawing. The accurate three-dimensional reconstruction can be performed finally, and thus which leads to an improvement in visibility for a user. For example, when an inspection image of the interior of a structure such as infrastructure equipment is used as a panoramic image, the user can obtain three-dimensional reconstructed data including information indicating a deteriorating portion of the interior. By using the data, structure calculation is performed to quantitatively evaluate soundness of the structure. In this way, according to the present embodiment, it is possible to three-dimensionally reconstruct a panoramic image of the interior of a structure which has a complicated shape of a wall surface of the interior and does not conform with the Manhattan-world hypothesis. Accordingly, it is possible to improve a technique for accurately performing three-dimensional reconstruction of an image of the interior of a structure in which an orthogonal system is not assumed.

As described above, the three-dimensional reconstruction device 10 according to the present embodiment includes: the first straight line detection unit 114 that detects a straight line in the generated plan view and specifies at least one intersection of the straight line as a first intersection; and the second straight line detection unit 115 that detects a straight line in the acquired drawing specifies at least one intersection of the straight lines as the second intersection. The registration unit 116 performs the alignment using the first and second intersections as the initial positions.

The accuracy of the alignment performed using the ICP algorithm greatly depends on the initial positions of the point groups. According to the present embodiment, the first and second intersections detected by the first straight line detection unit 114 and the second straight line detection unit 115 can be used as landmarks to perform the alignment. Since the first and second intersections serving as the corresponding landmark are automatically specified, the accuracy of the alignment is easily improved. Accordingly, it is possible to improve a technique for accurately performing three-dimensional reconstruction of an image of the interior of a structure in which an orthogonal system is not assumed.

As described above, in the three-dimensional reconstruction device 10 according to the present embodiment, the plan view generation unit 113 obtains a distance of a camera imaging a panoramic image to a wall surface of a structure, and plots the distance at each imaging angle in the horizontal direction of the camera to generate a plan view.

According to the present embodiment, a distance from the camera to the wall surface can be calculated based on the assumption that the ceiling height off the interior of the structure S is constant, and the plan view can be generated. The plan view can also be generated for a panoramic image in which the interior of a structure in which wall surfaces are not orthogonal, that is, a structure which does not conform with the Manhattan-world hypothesis is an imaging target. By performing the alignment based on the generated plan view, it is possible to reduce a calculation cost, and three-dimensional coordinates can be calculated even for a structure which does not conforms with the Manhattan-world hypothesis. Accordingly, it is possible to improve a technique for accurately performing three-dimensional reconstruction of an image of the interior of a structure in which an orthogonal system is not assumed.

Although the present disclosure has been described based on various drawings and embodiments, it should be noted that various modifications and corrections can be easily made by those skilled in the art based on the present disclosure. Accordingly, it should be noted that such modifications and corrections fall within the scope of the present disclosure.

### First Modification Example

Next, as a first modification example of the embodiment of the present disclosure, a case where the three-dimensional reconstruction device 10 is applied to a structure S2 different from the structure S of the above-described embodiment will be described. In the present modification example, since a configuration of each unit of the three-dimensional reconstruction device 10 is similar to that of the above-described embodiment, description thereof will be omitted.

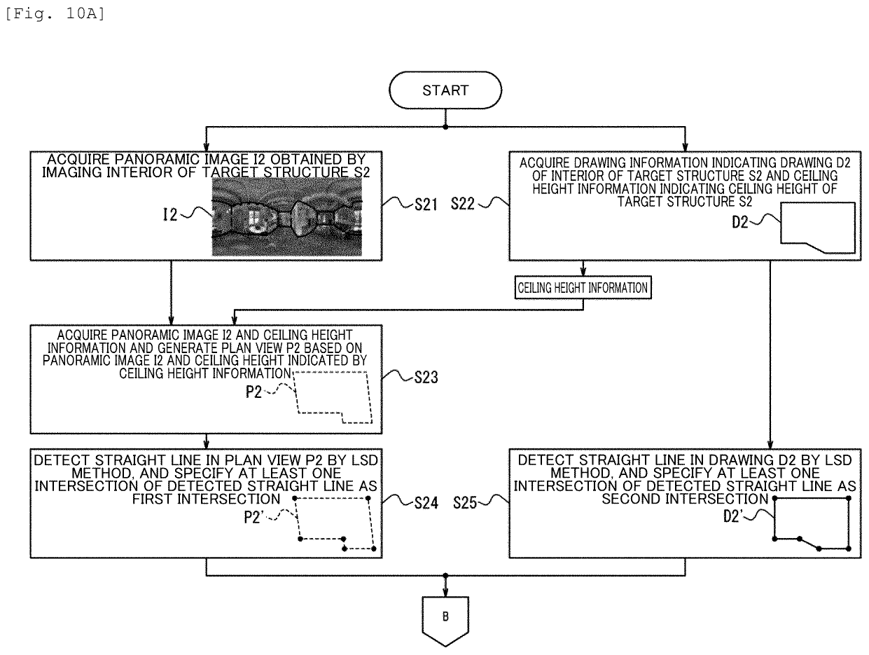

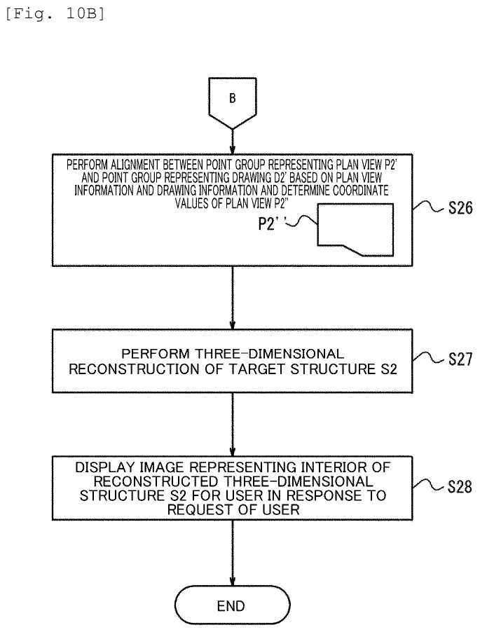

Hereinafter, differences between the operation of the three-dimensional reconstruction device 10 according to the above-described embodiment and an operation of the three-dimensional reconstruction device 10 according to the present modification example will be described with reference to FIGS. 10A and 10B. Steps S21 to S28 of FIGS. 10A and 10B correspond to steps S1 to S8 of FIGS. 9A and 9B of the above-described embodiment.

In the present example, it is assumed that the wall surface of the interior of the structure S2 is shielded by an object, and detection accuracy of a wall surface and a boundary line of a panoramic image 12 acquired by the panoramic image acquisition unit 111 in step S21 is low. In step S22, the drawing information acquisition unit 112 acquires drawing information indicating a drawing D2 of the interior of the target structure S2 and ceiling height information indicating a ceiling height of the target structure S2, outputs the drawing information to the second straight line detection unit 115 and outputs the ceiling height information to the plan view generation unit 113. In this case, in step S23, a distorted plan view P2 is generated by the plan view generation unit 113.

In a plan view P2′ of step S24, the first intersection and a straight line in the plan view P2 are detected by the first straight line detection unit 114. In a drawing D2′ in step S25, a straight line and the second intersection in the drawing D2 acquired by the drawing information acquisition unit 112 are detected by the second straight line detection unit 115.

In step S26 of FIG. 10B, the registration unit 116 performs the alignment using the detected first and second intersections as the initial positions. Accordingly, the registration unit 116 determines the coordinate values of the plan view P2″. In step S27, the three-dimensional coordinate calculation unit 117 performs three-dimensional reconstruction of the target structure S2, as in the above embodiment. In step S28, the control unit 11 displays an image representing the interior of the reconstituted three-dimensional structure S2 for the user in response to a request of the user, as in the above embodiment.

In this way, in the present modification example, even when the plan view generation unit 113 generates the distorted plan view P2, correction is performed with the drawing D2 given as input, and the registration unit 116 can finally determine the coordinate values of the plan view P2″ with no distortion. Accordingly, the three-dimensional reconstruction can also be performed from the panoramic image 12 in which the wall is shielded by the object and the detection accuracy of the wall surface or the boundary line is not high.

### Second Modification Example

Next, as a second modification example of the embodiment of the present disclosure, a case where the three-dimensional reconstruction device 10 is applied to a structure S3 different from the structure S of the above-described embodiment will be described. In the present modification example, since a configuration of each unit of the three-dimensional reconstruction device 10 is similar to that of the above-described embodiment, description thereof will be omitted.

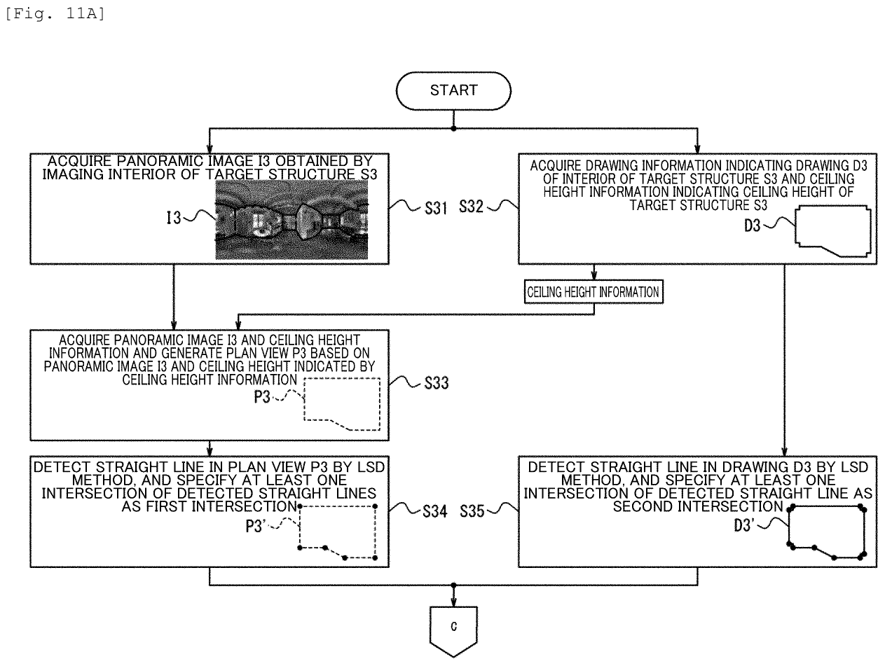

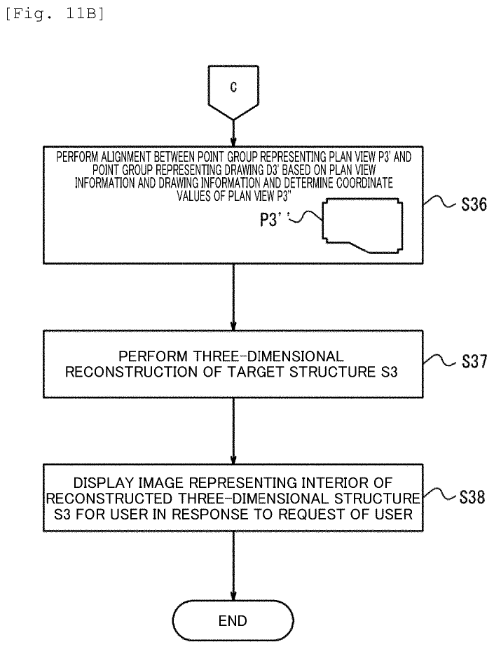

Hereinafter, differences between the operation of the three-dimensional reconstruction device 10 according to the above-described embodiment and an operation of the three-dimensional reconstruction device 10 according to the present modification example will be described with reference to FIGS. 11A and 11B. Steps S31 to S38 of FIGS. 11A and 11B correspond to steps S1 to S8 of the above-described embodiment.

In the present example, it is assumed that there is a column on a wall surface inside the structure S3, and detection accuracy of the wall surface and the boundary line of the panoramic image 13 acquired in step S31 by the panoramic image acquisition unit 111 is low. In step S32, the drawing information acquisition unit 112 acquires drawing information indicating a drawing D3 of the interior of the target structure S3 and ceiling height information indicating a ceiling height of the target structure S3, and outputs the drawing information to the second straight line detection unit 115 and outputs the ceiling height information to the plan view generation unit 113. In this case, in step S33, a distorted plan view P3 is generated by the plan view generation unit 113.

In a plan view P3′ of step S34, the first intersection and a straight line in the plan view P3 are detected by the first straight line detection unit 114. In a drawing D3′ in step S35, a straight line and the second intersection in the drawing D3 acquired by the drawing information acquisition unit 112 are detected by the second straight line detection unit 115.

In step S36 of FIG. 11B, the registration unit 116 performs the alignment using the detected first and second intersections as the initial positions. Accordingly, the registration unit 116 determines the coordinate values of the plan view P3″. In step S37, the three-dimensional coordinate calculation unit 117 performs three-dimensional reconstruction of the target structure S3, as in the above embodiment. In step S38, the control unit 11 displays an image representing the interior of the reconstituted three-dimensional structure S3 for the user in response to a request of the user, as in the above embodiment.

In this way, in the present modification example, even when the plan view generation unit 113 generates the plan view P3 with low accuracy, correction is performed by the drawing D3 which is given as input and in which the position of the column is reflected, and the registration unit 116 can finally determine the accurate coordinate value of the accurate plan view P3″. Accordingly, the three-dimensional reconstruction can also be performed from the panoramic image i3 which is expected not to be estimated accurately in the wall surface or boundary detection because of presence of a column on the wall surface.

The following supplements are disclosed according to the foregoing embodiments.

### (Supplement 1)

A three-dimensional reconstruction device including a control unit configured to:
acquire a panoramic image obtained by imaging an interior of a target structure;
acquire a drawing of the interior of the structure and a ceiling height of the structure;
generate a plan view of the interior of the structure based on the panoramic image and the ceiling height;
perform alignment between the generated plan view and the drawing and determine coordinate values of the plan view; and
perform three-dimensional reconstruction of the structure based on the determined coordinate values of the plan view.

### (Supplement 2)

The three-dimensional reconstruction device according to Supplement 1, wherein the control unit detects a straight line in the generated plan view and specify at least one intersection of the straight line as a first intersection, detects a straight line in the acquired drawing and specify at least one intersection of the straight line as a second intersection, and
performs the alignment using the first and second intersections as initial positions.

### (Supplement 3)

The three-dimensional reconstruction device according to Supplement 1 or 2, wherein the control unit obtains a distance of a camera imaging the panoramic image to a wall surface of the structure and plots the distance at each imaging angle in a horizontal direction of the camera to generate the plan view.

### (Supplement 4)

A three-dimensional reconstruction method executed by a three-dimensional reconstruction device, the method comprising:
a panoramic image acquisition step of acquiring a panoramic image obtained by imaging an interior of a target structure;
a drawing information acquisition step of acquiring a drawing of the interior of the structure and a ceiling height of the structure;
a plan view generation step of generating a plan view of the interior of the structure based on the panoramic image and the ceiling height;
a registration step of performing alignment between the generated plan view and the drawing and determining coordinate values of the plan view; and
a three-dimensional coordinate calculation step of performing three-dimensional reconstruction of the structure based on the determined coordinate values of the plan view.

### (Supplement 5)

The three-dimensional reconstruction method according to Supplement 4, further including:
a first straight line detection step of detecting a straight line in the generated plan view and specifying at least one intersection of the straight line as a first intersection; and a second straight line detection step of detecting a straight line in the acquired drawing and specifying at least one intersection of the straight line as a second intersection, wherein the registration step further including a step of performing the alignment using the first and second intersections as initial positions.

### (Supplement 6)

The three-dimensional reconstruction device according to Supplement 4 or 5, wherein the plan view generation step further includes a step of obtaining a distance of a camera imaging the panoramic image to a wall surface of the structure and plotting the distance at each imaging angle in a horizontal direction of the camera to generate the plan view.

### (Supplement 7)

A non-transitory computer-readable medium that stores a program causing a computer to function as the three-dimensional reconstruction device according to Supplement 1 or 2.

### REFERENCE SIGNS LIST

10 Three-dimensional reconstruction device
11 Control unit
12 Storage unit
13 Communication unit
14 Input unit
15 Output unit
111 Panoramic image acquisition unit
112 Drawing information acquisition unit
113 Plan view generation unit
114 First straight line detection unit
115 Second straight line detection unit
116 Registration unit
117 Three-dimensional coordinate calculation unit

1. A three-dimensional reconstruction device comprising a processor configured to execute operations comprising:
acquiring a panoramic image obtained by imaging an interior of a target structure as a target structure;
acquiring a drawing of the interior of the structure and a ceiling height of the structure;
generating a plan view of the interior of the structure based on the panoramic image and the ceiling height;
performing alignment between the generated plan view and the drawing;
determining coordinate values of the plan view; and
performing three-dimensional reconstruction of the structure based on the determined coordinate values of the plan view.

2. The three-dimensional reconstruction device according to claim 1, the processor further configured to execute operations comprising:
detecting a straight line in the generated plan view and specifying at least one intersection of the straight line as a first intersection; and
detecting a straight line in the acquired drawing and specifying at least one intersection of the straight line as a second intersection,
wherein the performing alignment further comprises performing the alignment using the first and second intersections as initial positions.

3. The three-dimensional reconstruction device according to claim 1, wherein the generating a plan view further comprises obtaining a distance of a camera imaging the panoramic image to a wall surface of the structure and plotting the distance at each imaging angle in a horizontal direction of the camera to generate the plan view.

4. A method for reconstructing a three-dimensional reconstruction executed by a three-dimensional reconstruction device, comprising:
acquiring a panoramic image obtained by imaging an interior of a target structure;
acquiring a drawing of the interior of the structure and a ceiling height of the structure;
generating a plan view of the interior of the structure based on the panoramic image and the ceiling height;
performing alignment between the generated plan view and the drawing and determining coordinate values of the plan view; and
performing three-dimensional reconstruction of the structure based on the determined coordinate values of the plan view.

5. The method according to claim 4, further comprising:
detecting a straight line in the generated plan view and specify at least one intersection of the straight line as a first intersection; and
detecting a straight line in the acquired drawing and specify at least one intersection of the straight line as a second intersection,
wherein the performing alignment further comprises performing the alignment using the first and second intersections as initial positions.

6. The method according to claim 4, wherein the generating a plan view further comprises obtaining a distance of a camera imaging the panoramic image to a wall surface of the structure and plotting the distance at each imaging angle in a horizontal direction of the camera to generate the plan view.

7. A program causing a computer to function as the three-dimensional reconstruction device according to claim 1.

8. The three-dimensional reconstruction device according to claim 1, the processor further configured to execute operations comprising:
displaying the three-dimensional reconstruction of the structure as output in a display of a virtual reality (VR) goggle.

9. The three-dimensional reconstruction device according to claim 1, wherein the three-dimensional reconstruction of the structure represents an inspection image of the interior of the structure by infrastructure equipment.
